(19) United States
(12) Patent Application Publication
(10) Pub. No.: US 2017/0046688 A1
(43) Pub. Date: Feb. 16, 2017

(54) DEVICE, SYSTEM AND METHOD FOR EFFICIENTLY SERVICING HIGH VOLUME ELECTRONIC TRANSACTIONS

(71) Applicant: NUCLEUS SOFTWARE EXPORTS LIMITED, NEW DELHI (IN)

(72) Inventor: ASHUTOSH PANDE, NOIDA (IN)

(21) Appl. No.: 15/304,617

(22) PCT Filed: Apr. 15, 2015
(86) PCT No.: PCT/IN2015/000170

§ 371 Date: Oct. 17, 2016

(30) Foreign Application Priority Data
Apr. 16, 2014 (IN) 1040/DEL/2014

(51) Int. Cl. G06Q 20/36; G06Q 20/10; G06Q 20/20; G06Q 20/32

(52) U.S. Cl. CPC G06Q 20/36; G06Q 20/3223; G06Q 20/3278; G06Q 20/1085; G06Q 20/20; G06Q 30/0226

(57) ABSTRACT

The present invention provides a system for implementing electronic transactions between various users in a financial system. The system includes a server for storing financial and personal information of the users, a transaction terminal capable of connecting to the server via a wide area network, and multiple digital wallets capable of communicating with each other and with the transaction terminal. The one or more digital wallets carry electronic transactions with each other and synchronize the carried electronic transaction when the digital wallet gets communicably coupled to the transaction terminal.

### CROSS REFERENCE TO RELATED APPLICATIONS

This complete specification is filed in pursuance of the provisional Indian patent application numbered 1040/DEL/2014 filed at India Patent Office on 16 Apr. 2014.

### FIELD OF THE DISCLOSURE

The present disclosure generally relates to the field of electronic transactions, and more particularly, to systems and methods for implementing high volume electronic transactions.

### BACKGROUND OF THE DISCLOSURE

There has been a tremendous increase in the demand of cashless transactions in recent years. There is a fast moving trend towards developing systems and methods which facilitate electronic and cashless transactions as a preferred way of financial transactions as compared to cash based transactions. It is envisaged that such cashless transaction has tremendous benefits and can save huge costs to exchequer by reducing or eliminating the dependence on paper and currency notes based transactions. Furthermore, the speed of financial transaction increases by reducing and eventually removing cash management from the value chain.

One of the first forms of cashless transactions started with credit cards that are widely accepted by merchants through Point of Sale (POS) terminals, vending machines, ticketing machines, and the like. In this technology, users can swipe their card and carry out the financial transaction after providing certain authorization information, such as Personal Identification Number, signature, biometrics, and the like. At the end of a specified period, the card user receives a statement, which in the case of a credit card contains an invoice for payment. The user then pays the amount due settling the invoice with the merchant. Various other cards, such as debit cards, are more widely used in economies where access to credit is unavailable. In debit cards, the transactions are against the users' money in their bank accounts and conducted with real time connection from the Point Of Sale to the financial organization. While these solutions provide convenience to users, they entail a cost to the merchant. Therefore, merchants are generally reluctant to support this payment, method for small value transactions.

Another way of part cashless transaction is via the ATM banking machines. Usually in ATM banking machines, a card is inserted by a user into the reader of the machine which reads the coded information about the account of the user. The card user thereafter enters a secret number, usually referred to as PIN. If the code is correct, the user is able to perform the banking transaction in which he or she may do many activities including depositing cash, depositing checks, withdrawing cash or checking balance. The ATM user usually receives a receipt for the transaction. Later the user also receives a paper record of his or her transactions for the month from the banking institution.

However, all these conventional systems involve a transaction between a user on one side and a merchant on the other side. Further, all these conventional systems assume that the user has a bank account, certain degree of education to operate the account, and ready access to credit. Moreover, all these conventional systems require the user to be in proximity to a POS or ATM for gaining real time access to their bank account as well as access to physical money. Therefore, despite many fold advantages of these electronic transaction systems in curbing black money, increasing transparency, and saving huge operational costs and investments, their implementation and reach is significantly restricted. For aforesaid reasons these electronic transaction methods have been unable to ingrain themselves in day to day life of present day users.

Moreover, it has been found that access to bank accounts is still unavailable to many people in developing countries. Governments around the world are working on various initiatives to bring financial inclusion. Various approaches have been implemented with varied success, and with limitations. The biggest limitation is the essentiality that the users should have bank accounts with licensed banks. It will be appreciated that usually banks have certain fixed costs for running their operation and accordingly there is a limitation on the users they would like to be their customers.

Other approaches that have been used by governments include creating a model of bank representation. In this model, banks create banking correspondents, who act as agents for the bank and assist with basic banking facility. These entities have developed their own platform and distribution network to collect physical money from depositors and depositing it at the partner bank. They perform these services of bank deposit, transfer/remittance, withdrawal and balance inquiry by converting physical money to e-money on their platform and using information technology to effect the transactions.

Having said that, this approach suffers from the challenge of cash management, the ability to take physical money to the partner banking establishment for conversion into e-money. Once a correspondent is out of his or her e-money balance they cannot conduct additional transactions. Therefore, during peak transaction days like payday or festivals, the correspondent ends up losing out on business. Services from business correspondents are also limited during long weekends with bank holidays. In summary cash management has been a major issue which has limited the success of this approach to inclusive banking.

Organizations have used technology based solutions for financial inclusion. For example, many organizations have used mobile technology, referred to as mobile wallets. These mobile wallets are based on the premise of precluding the need of bank accounts. Usually, in mobile wallet model, a user may ‘charge’ their mobile using physical money and then use the charge ‘e-money’ to transfer funds to another mobile number or to make payments. These funds may then be used for only those services supported by the mobile operator, which is a significant limitation.

Moreover, in such conventional systems, the access to services is generally closed in nature. For example, a user may only obtain service from qualified merchants. This is similar to EVM (Euro, VISA, Mastercard) and the like systems, where services are available to only those who carry the card and in only those locations which carry an EVM POS. Therefore, there is a tremendous need of developing systems and methods for improving existing electronic transaction systems which have a broader reach and are more open in nature as with a conventional wallet.

There is an earnest belief that such need of efficient electronic systems will increase in near future, especially considering the governmental emphasis in reducing pilferage in the distribution of government subsidies, and increasing transparency. Governments are even pondering on ways to directly distribute funds to end beneficiaries. However, as emphasized above, this entails that the beneficiaries have a bank account. The reality is that in emerging economies most of the recipients of government aid do not have a bank in close vicinity of their homes. Even though the beneficiaries have bank accounts, in many cases it is a logistical challenge for them to gain access to these funds; since, access might entail walking miles to the closest banking establishment. This is further compounded with the fact that a considerable number of such users lack basic education and reading skills, rendering the ATMs unusable to such users. Lack of real time data connectivity or 24 hour electricity also limits the penetration of existing electronic solutions.

Therefore, there is a tremendous need to develop efficient systems and methods that would provide means for improving electronic transaction capabilities. There is a need to reduce the number of transactions requiring real time connectivity to core banking network. There is a need to reduce the number of transactions coming to a central node for validation. There is need to enable non-POS or ATM e-money transactions, especially enabling transactions between two individuals offline without the need for a third party or intermediary. There is a further need to develop systems and methods that can provide uninhibited freedom to users for utilizing electronic money. Moreover, there is a need to reduce or remove physical money as much as possible thus reducing the last mile problem of cash management, and to use the penetration of internet and mobile telephony to replace traditional brick and mortar banking infrastructure; while still empowering the end user.

There have been various some solutions developed in recent years to facilitate peer to peer electronic transactions. For example, in U.S. Pat. No. 8,315,952 by Ken Algiene, methods and systems are described for transferring funds from a sender to a recipient. Source funds are received from a sender. An amount of recipient funds is determined from a value of the source funds. A transfer identifier associated with the recipient funds is generated and provided to the sender. The transfer identifier is received from the recipient, prompting a transfer in control of the recipient funds to the recipient. At least one of the source funds and the recipient funds are in the form of one or more electronic tokens. Each such electronic token has a currency amount and a digital signature identifying a financial institution that backs the electronic token for the currency amount.

However, Ken Algiene does not provide a solution to overcome the problem of distributing the financial transactions using one or more electronic devices such as a mobile device without the need of financial institution. For example, This approach is akin to the current approach of taking ‘debits’ and going to the bank and changing them for ‘credit’ In the above situation, the above system fails rotate the financial transactions between various users in an efficient and economical manner, taking into consideration the limitations of coverage of Wide Area Network, such as the internet.

In nutshell, there is a tremendous need to develop efficient systems and methods that would provide means for improving electronic transaction capabilities. There is a need to reduce the number of transactions requiring real time connectivity to core banking network. There is a need to reduce the number of transactions coming to a central node for validation. There is need to enable non-POS or ATM e-money transactions; especially enabling transactions between two individuals offline without the need for a third party or intermediary. There is a further need to develop systems and methods that can provide uninhibited freedom to users for utilizing electronic money. Moreover, there is a need to reduce or remove physical money as much as possible thus reducing the last mile problem of cash management, and to use the penetration of internet and mobile telephony to replace traditional brick and mortar banking infrastructure; while still empowering the end user.

### SUMMARY OF THE DISCLOSURE

In view of the foregoing disadvantages inherent in the prior-art and the needs as mentioned above, the general purpose of the present disclosure is to provide a system for implementing electronic transactions between various users in financial systems, such as a banking system that is configured to include all advantages of the prior art and to overcome the drawbacks inherent in the prior art offering some added advantages.

To achieve the above objectives and to fulfill the identified needs, in one aspect, the present disclosure provides a system for implementing electronic transactions between various users in a banking system. Specifically, the system is adapted to allow various devices to carrying electronic transactions in an offline manner or mode, i.e., without the need of an omnipresent and uninterrupted connectivity to a network backbone. The system includes a server for storing financial and personal information of the users, a transaction terminal capable of connecting to the server via a wide area network and multiple digital wallets capable of communicating with each other for carrying out electronic transactions, and with the at least one transaction terminal. Further, the system allows the digital wallets to synchronize the carried electronic transaction when the digital wallet gets communicably coupled to the transaction terminal.

In one embodiment, the system further includes at least one hub capable of connecting to the server via the wide area network. Each of the at least one hub is coupled to the server and to the at least one transaction terminal via wide area networks.

In another aspect, the present invention provides a method for implementing electronic transactions between various users, each of the users carrying a digital wallet as described above. The method includes enabling a first digital wallet. After enabling the first digital wallet, the method includes selecting one of the one or more digital wallets to transact with, and sending an electronic transaction request to the selected digital wallets from the first digital wallet via a communication means. Further, the method includes carrying the electronic transaction between the first digital wallet and the selected digital wallets in an offline manner.

In one embodiment, the method includes synchronizing the electronic transaction with a server when either of the first digital wallet or the selected digital wallet gets communicably coupled to the wide area network, such as the internet.

In another embodiment, the method includes synchronizing the electronic transaction with a hub coupled to the server, when either of the first digital wallet or the selected digital wallet gets communicably coupled to the wide area network, such as the internet.

In another aspect, the present invention provides a method for implementing electronic transactions between various users, wherein each of the users carrying a digital wallet and at least one transaction terminal. The method includes enabling at least one transaction terminal. Thereafter, the method includes selecting either one of the one or more digital wallets and the at least one transaction terminal to transact with, and sending an electronic transaction request to the selected either one or more digital wallet and the at least one transaction terminal from the first digital wallet via a communication means.

The method further includes carrying the electronic transaction between the selected digital wallet or the at least one transaction terminal in an offline manner, wherein the electronic transaction gets synchronized with the server or the hub and when either of the one or more digital wallets and the at least one transaction terminal gets communicably coupled to the wide area network.

Further, it should be understood that the transaction between two digital wallets is adapted to take place without the need for any synchronization of the electronic transactions.

This together with the other aspects of the present invention along with the various features of novelty that characterized the present disclosure is pointed out with particularity in claims annexed hereto and forms a part of the present invention. For better understanding of the present disclosure, its operating advantages, and the specified objective attained by its uses, reference should be made to the accompanying descriptive matter in which there are illustrated exemplary embodiments of the present invention.

### BRIEF DESCRIPTION OF THE DRAWINGS

The advantages and features of the present disclosure will become better understood with reference to the following detailed description and claims taken in conjunction with the accompanying drawing, in which:

FIG. 1A-1B illustrates a block diagram of a digital wallet of the present invention, according to various embodiments of the present invention;

FIG. 2 illustrates a digital wallet being implemented as a Software Based Digital Wallet, with the said digital wallet running on a tablet or mobile phone instead of a standalone hardware device, according to various embodiments of the present invention;

FIG. 3 illustrates a perspective view of the digital wallet when implemented as a wearable device, according to various embodiments of the present invention;

FIG. 4A-4D illustrates block diagrams of a system for implementing electronic transaction between various users of digital wallets in financial systems, such as a banking system, according to various embodiments of the present.

FIG. 5 illustrates a block diagram of a system for enabling high volume electronic transactions, according to various embodiments of the present invention;

FIG. 6 illustrates an implementation of the system for carrying out electronic transactions, according to various embodiment of the present invention;

FIG. 7 illustrates an implementation of the system for carrying out electronic transactions between subscribers even if they are registered with of two different financial institutions, according to various embodiments of the present invention;

FIG. 8 illustrates a distributed architecture model for carrying out transactions, according to various embodiments of the present invention; and

FIG. 9 illustrates online and offline implementation of electronic transactions, including the aspect of a temporary repository of available balance for out of station user, according to various embodiments of the present invention; and

FIG. 10 illustrate flow charts for implementing electronic transactions between various users carrying a digital wallet, according to various embodiments of the present invention.

Like numerals refer to like elements throughout the present disclosure.

### DETAILED DESCRIPTION OF THE DISCLOSURE

The exemplary embodiments described herein for illustrative purposes are subject to many variations in structure and design. It should be emphasized, however, that the present invention is not limited to method and system for performing high volume electronic transactions. It is understood that various omissions and substitutions of equivalents are contemplated as circumstances may suggest or render expedient, but these are intended to cover the application or implementation without departing from the spirit or scope of the present invention.

The terms “a” and “an” herein do not denote a limitation of quantity, but rather denote the presence of at least one of the referenced item.

The terms “having”, “comprising”, “including”, and variations thereof signify the presence of a component.

The present invention provides systems and methods for providing high volume electronic transactions, according to various embodiments of the present invention. It should be noted that the term “electronic transaction” as referred herein refers to a financial transaction carried out electronically, without need of cash or without involving exchange of monetary currency. The systems and methods focus on overcoming the key issue of non-existing bank accounts of various parties involved in facilitating the electronic transactions. The present invention envisages use of electronic money by using electronic version of a wallet (also interchangeably referred to as “digital wallet”) to replace cash carried by users in their wallets.

However, it should be appreciated that ‘electronic transaction’ could also apply to non-financial transactions and it is the intent of the present invention to leverage the platform as a prepaid financial instrument as well as a pre authorized access card.

The solution consists of a core platform which is capable of interfacing with existing systems, financial or otherwise, on one side and a distributed digital wallet network. The core platform interacts in a distributed fashion with either a single or multiple instances depending upon the loading of the platform.

In the solution, the user base is broken into zones, initially at the state, then District and so forth till the individual village level. Each user is associated with a hub referred to their ‘home hub’, usually at the village or district level. The hub almost always maintains connectivity with the core platform and any change in the customer account details are immediately replicated in the repository at home hub, referred to as the Home Account Register (HAR). Each hub also contains a separate register where details of all visitors into the zone are recorded. This is referred to as the Visitor Account Register (VAR).

Moreover, when a user enters a new zone and tries to transact with his or her digital wallet for the first time, the wallet registers itself with the system and the account details of the user, including his available balance in the wallet, are transferred into the VAR. This first interaction usually takes time and requires some synchronization with the core platform. Enhancements can be done to the system, based on their credit history, and the like, where a visitor may be allowed to conduct transactions without the need to first synchronize their account. Once the device is synchronized with the backend and an image of the account established in the VAR, all transactions by the user while in that zone can be conducted without having to go back to the Home Account Register (HAR) or to the financial institution. This allows for transactions to be conducted more efficiently and makes the platform scalable.

At the platform level, the architecture allows for a seamless transfer of limited funds from a bank account into a ‘wallet account’ onto the platform as e-money. This interaction is akin to withdrawal of physical money from the banking platform by way of going to an ATM or bank outlet and transferring it onto a physical wallet.

The funds transferred to the wallet account are immediately pushed to the HAR and transferred onto the digital wallet when the wallet establishes a link with the Hub.

In the initial seeding stage, funds can also enter this platform from any POS or Kiosk by way of conversion of physical money to e-money.

The typical technology involved in the digital wallet includes capabilities which allows storing, transmitting and receiving of personal and transactional information, and thereby replacing key items in a physical ‘wallet’. Just as a wallet may contain one or more plastic cards, each representing an account, the digital wallet is designed to support multiple accounts. In one implementation of the invention, the digital wallet of the present invention is a pocket sized device, which includes a microprocessor, RAM, display, speaker, microphone and input output means. In another embodiment, the digital wallet may be emulated as a software application on a mobile phone. Moreover, the digital wallet device is capable of saving various information about the user, referred to as KYC (Know Your Customer) information. It may also carry information on the various banks with which it can connect.

Accordingly, the digital wallet allows users to imitate various transactions that are usually done with physical currency notes. Suitable examples of such activities may include but are not limited to withdrawing cash from a bank account, storing the cash, taking out cash from the wallet to pay to a vendor, paying cash to another user, depositing cash from the wallet to the bank account, and other similar activities. The present invention further allows carrying out transactions without the need to be connected to a network backbone.

The present invention further attempts to provide flexibility and convenience of a cash wallet in form of a digital wallet. On the other hand, the present invention does not allow any compromises on security aspects, thereby making transactions carried out by the digital wallets as highly safe, accurate and secure. For example, when compared with open nature of a physical wallet, the authentication mechanisms in the digital wallet provide a highly restrictive protection than physical cash. Furthermore, the digital wallet is capable of storing more than just e-money. It can carry other information like driving license, health card with health file and various membership cards to name a few.

The digital wallets of the present invention use ultra-low power wireless technologies for data transfer, which ensures that the wallet can be used for extended periods, in some cases several years, without the need of recharging or replacing batteries. These wallets have been explained in details in the co-pending application No. 1041/DEL/2014 filed at India Patent Office on 16 Apr. 2014.

Further, the digital wallets of the present invention assure that once two users are carrying out transactions, they are doing so in close proximity, thereby mimicking a typical cash transfer without the need to connect to a backend platform. The present invention further precludes the need of physically touching or tapping the two devices to effect a transaction but still provides a similar level of security by placing requirements for the devices to be in close vicinity (like a few centimeters) in order to effect transactions. Accordingly, in case of a payment transaction, even though the users may not need to touch the digital wallets to Point of Sale (POS), they still need to bring it within a few centimeters of the POS for carrying out transactions. This requirement implies an explicit authentication by requiring physical presence of the digital wallet holder and eliminates the risk of MITM (Man-In-The-Middle) attacks.

The present invention further has additional level of security by keeping the wireless device in off mode most of the time. The digital wallets are switched on only when a transaction is to be done, akin to taking a physical wallet out of the pocket or purse, and then the digital wallet may automatically be switched off. Even while the digital wallet is switched on, the digital wallet remains visible only for a very brief period of time. Such action significantly reduces the time span that is available for any malware to attack the digital wallet, thereby significantly enhancing the security aspects of the digital wallet. Furthermore, the wallet never broadcasts its balance. It only receives request for a debit, which has to be approved by the wallet holder. Besides security, the digital wallet works on mechanism which helps in making the device power efficient and reduces the need for regular recharging or replacement of batteries.

The present invention further allows multi-level security by using a combination of one or more of the following: unique user ID, device ID, PIN Code entry and biometrics, for corroboration and authentication. Biometric information, such as finger prints, facial, retina scans, voice, is always unique to each individual. These features preclude the possibility in which users suffer from problems, such as forgetting PIN number, or a hit-and-trial attack on the digital wallet by entering possible PIN numbers. The wallet has a lock-in feature after successive entries. Once the wallet is locked, the owner has to connect with the system for unlocking.

Moreover, the present invention, in one of its embodiment, adds an optional iconic Input/Output for users who have limited literacy or are visually challenged. For such users who are illiterate, the digital wallet uses icons to display currency. More specifically, the digital wallet uses icons of currency of 1, 5, 20, 50 and 100, and the like. Such icons make the digital wallets easy to use by such users. For example, if a user has to enter an amount of 140, the user is required to press the 100 button provided on the digital wallet once, followed by pressing the 20 button two times. In one embodiment, the buttons may have braille markings, thereby allowing visually impaired users to enter amounts conveniently. The digital wallet may additionally play an audio feedback (such as reciting amount that was entered in the local dialect) to indicate and validate the amount entered.

Moreover, the digital wallet of the present invention is highly safe when integrated with financial backbone for concluding transactions. It will be appreciated by persons skilled in the art that as with any financial transaction, security of the transaction is of utmost importance. The present invention provides for several security measures to ensure that the transactions are carried on in a secure manner. In the unfortunate event of the digital wallet being lost, the present invention provides a mechanism to lock and black-list the digital wallet so that no further transactions can be done with that particular digital wallet. In such scenario the remaining money in that digital wallet may be safely transferred to another digital wallet once the old digital wallet is locked. This provides a degree of protection not accorded by traditional financial instruments like debit cards.

The digital wallet further includes storage capability to keep a record of the cash balance within the digital wallet, and other storage features like transaction details between networks connects. This removes the need of the digital wallet always being connected to the network backbone to get information about the balance or to conduct transactions. This assists in several ways, including keeping the cost of digital wallet low, reducing traffic on the network backbone, recurring cost in terms of any internet usage fee and according low power consumption.

Moreover, in various embodiments, the digital wallet uses the POS as a gateway to synchronize the balance with the financial institution as and when needed. In such a case, the digital wallet communicates with the POS whenever it comes under the communication field of the POS. In another embodiment, a hardware based digital wallet is configured to interact with software based digital wallet which in-turn connects to the network backbone for conciliation and reconciliation. This allows synchronization between the hardware based wallet and the software based wallet so that the balance of both the hardware based digital wallet and software based digital wallet may be synchronized with the network backbone of the financial institution.

A variant of the digital wallet is designed as a multi-modal unit where in one mode it acts as a digital wallet as defined in the present invention and in another mode it works as a conventional card using the magnetic strip, NFC or smart chip.

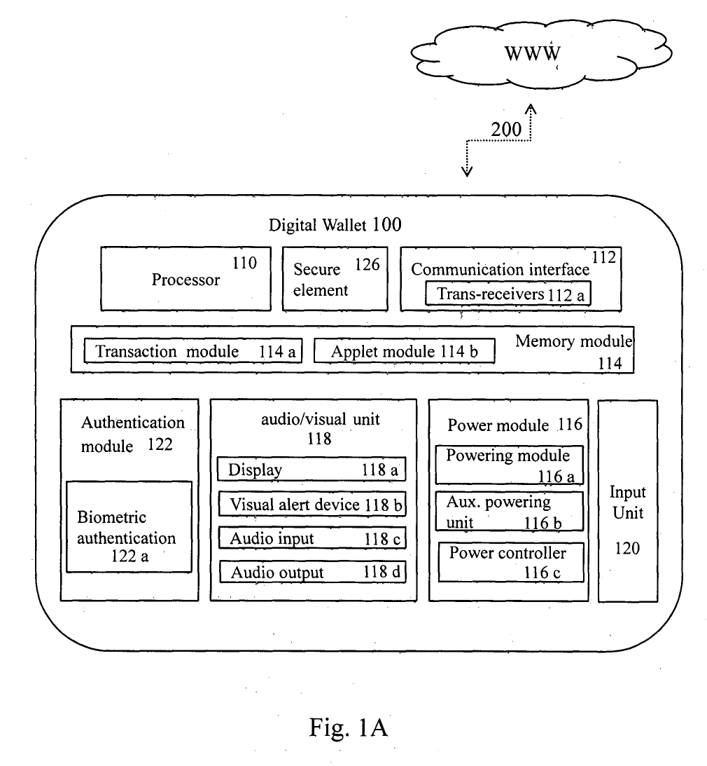

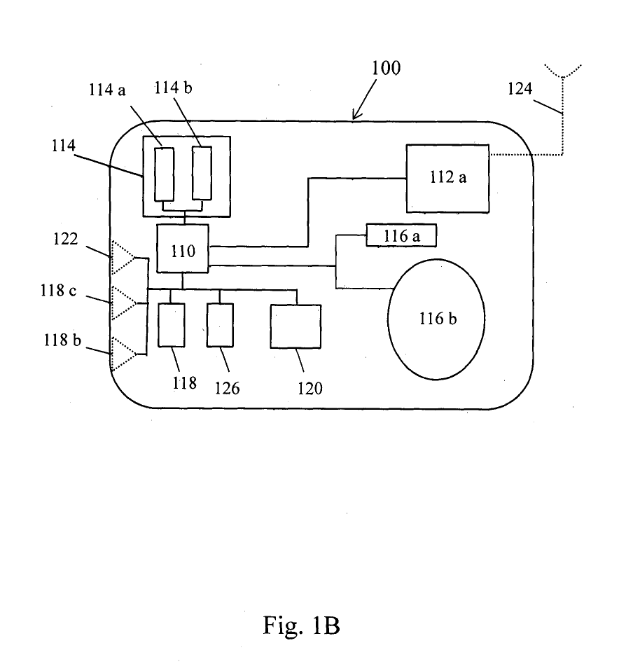

The digital wallet and its usage are described with reference to FIGS. 1-3.

Referring to FIGS. 1A and 1B, there is shown a digital wallet 100. The digital wallet 100 includes a communication interface 112. The communication interface 112 is adapted to send data to other digital wallets and receive data from other digital wallets or to other components of the system, such as Point of Sale (POS) device, and the like. In an exemplary embodiment, the communication interface 112 may include one or more wireless trans-receiver 112a, which is capable of transmitting or receiving data.

Further, the digital wallet 100 includes a Wireless Antennae 124. The wireless antenna 124 is adapted to connect the digital wallet 100 wirelessly with other devices, such as transaction terminals and other digital wallets.

Furthermore, the digital wallet 100 includes a processor or a microprocessor 110 for executing instructions, and a memory 114 storing some instructions. Specifically, the memory 114 includes a storage means for storing financial or user's personal information. Examples of information includes, but are not limited to, transaction information, various currency types, Unique Identification (UIADI) including Biometrics information, Social Security Number (SSN), Aadhar number, Driver's License (DL) Number, loyalty points information, frequent flyer miles information, and club membership information, and the like, for one or more users using the digital wallet 100.

In various embodiments, the memory 114, also includes an applet module 114b. This module 114b may contain various secure applets, adapted to perform intended function. In one embodiment, the secure applet could be used for validation of a person, driver license. In another embodiment, it could be used as a payment instrument for local transportations.

In various embodiments, the memory 114 could be in one or more physical manifestation. Furthermore, the memory 114 includes a transaction module 114a adapted to carry an electronic transaction in an offline manner. The transaction module 114a may be a software application having computer readable instruction, computer program and the like. In one embodiment, the transaction module 114a may be downloadable in the memory 114 of the digital wallet 100. Particularly, the transaction module 114a may be downloadable from any network or storage source, for example, but not limited to, Internet, CD ROM, USB and the like. For example, a user of the digital wallet 100 may download the transaction module 114a from the internet and install the said transaction module 114a on the digital wallet 100. Further, the memory 114 may include a Random Access Memory (RAM), Read Only Memory (ROM), and FLASH memory and the like.

Further, the transaction module 114a is adapted to perform various functions. In one embodiment, the transaction module 114a is adapted to validate the carried electronic transaction in the offline manner, as per the invention. However, such function of the transaction module 114a should not be construed as a limitation to the present invention. Accordingly, the transaction module 114a may be capable of performing other functions in the digital wallet 100.

Referring to FIGS. 1A and 1B, the digital wallet 100 further includes various security features for securing the digital wallet 100. The security features are important to prevent unauthorized access of the digital wallet 100, secure exchange of data with other wallets, and to make sure that only valid users are able to use the digital wallet 100.

In one embodiment, the digital wallet 100 includes an authentication module 122 coupled to the transaction module 114a. The authentication module 122 is adapted to authenticate the user of the digital wallet 100. It will be apparent to a person skilled in the art that security is paramount for these digital wallets, such as digital wallet 100. In one embodiment, the authentication module 122 may be a secure chip or a biometric type authentication module. In this case, the authentication module 122 further includes a Biometric Input unit 122a which may be adapted to provide additional support for biometric identification like finger print, retina, voice or facial detection. It enhances the overall security of the digital wallet 100. In addition, in various embodiments of the present invention, the digital wallet 100 may include various biometric units, for example camera, iris scanner, retina scanner, DNA identification device and the like which may strengthen the user authentication for accessing the digital wallet 100. However, such example of the biometric type authentication should not be construed as a limitation to the present invention. Accordingly, in another embodiment, the authentication module 122 may be any other authentication module, such as Person Identification Number (PIN) or signature based authentication module.

The digital wallet 100 further includes a secure element 126 for providing enhanced security to the digital wallet 100. It includes security keys and cyphers that are used to establish the identity of the device, functionality to encrypt and decrypt all communication that happens with other devices on the wireless network and functionality to store the sensitive information on the device in a secure manner. The encryption of the communication is highly essential in maintaining the security of the digital wallet 100. The secure element 126 also provides for currency storage, preparation of payment and verification of payment between digital wallets.

Referring to FIGS. 1A and 1B, the digital wallet 100 includes a power module 116 adapted to harvests energy from the environment and conserve power requirements of the digital wallet 100. The power module 116 satisfies the power need of the digital wallet 100. The power module 116 may include various oscillators, timers and other circuitry elements for such purpose.

In one embodiment of the present invention, the power module 116 includes powering unit 116a (such as a rechargeable battery source), an auxiliary powering unit 116b, which may include one or more solar panel units, and a power controller unit 116c. The power controller 116c is adapted to cease power of the digital wallet 100 in one or more predefined situations.

In one embodiment, the power controller 116c is adapted to control the power supply in one or more predefined situations. The predefined situations includes a situation where the power controller 116c automatically turns off or reduce power consumed by the digital wallet 100 after the completion of the electronic transaction or in a situation where the digital wallet 100 is inoperable for predetermined duration of time, for example 5-10 seconds. This assists the digital wallet 100 to save power, a key requirement for operating in remote areas.

Referring to FIGS. 1A and 1B again, in one embodiment, the digital wallet 100 also includes an audio/visual unit 118 adapted to provide various visual/Audio notification including alerts. Suitable examples of alerts or tags may include tags for events such as Deposit or Withdraw in the linked Bank Account, Low Balance, Low Battery, invalid authentication and the like. This makes the digital wallet 100 easy to operate and more importantly disable friendly.

In one embodiment, the audio/visual unit 118 includes a display 118a, an audio Input 118b, an Audio Output 118c and a Visual alert device 118d, are optional features of the present invention. The Audio Input 118b may be adapted to provide biometric identification of the user of the digital wallet 100 by voice recognition method. Further, the Audio Output 118c is adapted to provide audio feedback to the user. This audio output functionality is extremely beneficial for impaired or less educated or illiterate users.

Further, the digital wallet 100 includes a user Input unit 120. The user Input unit 120 is an essential interface between the digital wallet 100 and the user thereof. The Input unit 120 could be through a touch interface in lieu of a physical button. The user Input unit 120 uses iconic or alphanumeric based input. Accordingly, the Input unit 120 may include one or more keys for allowing the user to enter the input. However, such examples of the Input unit 120 should not be construed as a limitation of the present invention. Accordingly, the Input unit 120 may also be a gesture based, or a voice based input unit, or any other type of Input unit 120 which allows a seamless interfacing between the user and the digital wallet 100.

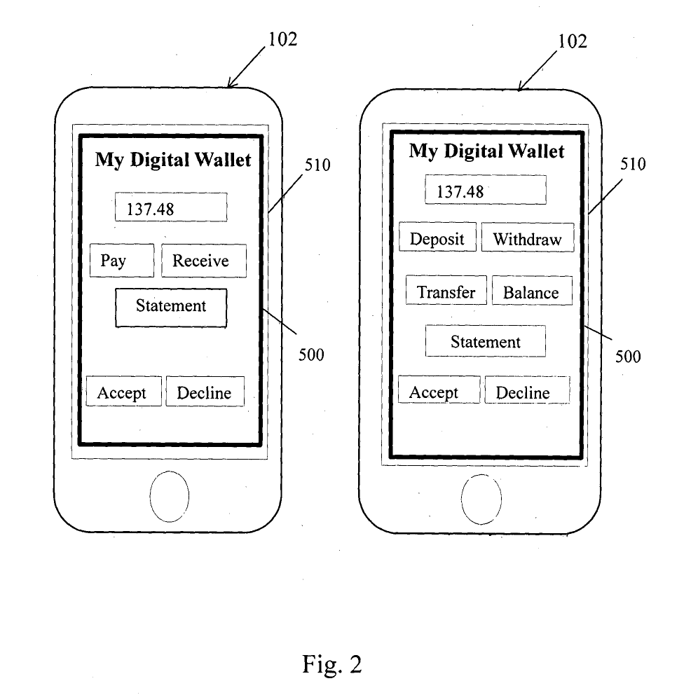

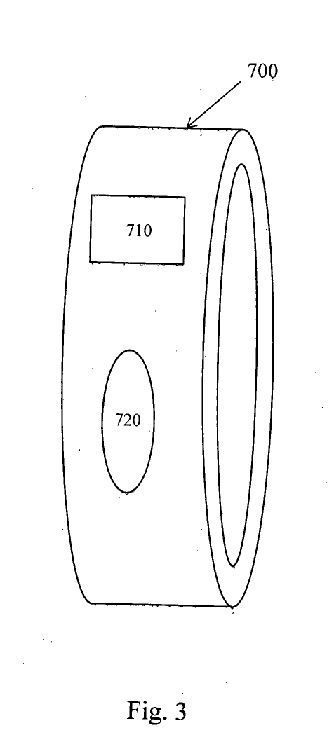

In one embodiment of the present invention, the digital wallet 100 may be implemented entirely at a software level. In such scenario, the digital wallet 100 may be in form of a software module 500 (as shown in FIG. 2) configurable onto known in the art data processing devices 102, such as smart phones, tablet computers and the like, as shown in FIG. 2. It will be apparent to the person skilled in the art, that the data processing device 102 may already include the communication interface 112, the processor 110, the secure element (not shown in FIG. 3) and the memory 114 (not shown in the FIG. 2) inherently in the device 102.

In one embodiment of the present invention, the digital wallet may be built into a form factor that can attach into a Smartphone or tablet, either externally or internally. For example the digital wallet may fit into the Smartphone into the USB, Audio, SIM card or SD card slot.

A reference is now made to FIG. 2, which illustrates an interface of the digital wallet 100 at the software level. As shown in FIG. 2, the module 500 is configurable on the device 102. An interface 510 as shown in FIG. 2 illustrates options to pay and receive, for example to pay currency, reward points, shopping credits or other such payment options. An interface 510 as shown in FIG. 2, illustrates options to conduct transactions, such as banking transactions including Deposit, Withdraw, Transfer, and Balance Inquiry. However, it should be clearly understood that such transaction and/or schematic layout of the digital wallet 100 should not be construed as a limitation to the present invention. The layout is highly adaptable and customizable according to the needs and desires of the user. The transactions by the digital wallet 100 are customizable in accordance with various situations.

Referring to FIG. 3 there is shown a digital wallet 700 when implemented as a wearable device, such as a wrist band, bracelet, ring or necklace. The various components include a wearable unit 700, a display 710 for displaying information, at least one button 720 allowing users to perform operations. This implementation gives tremendous portability to the digital wallet 700. In other words, the user is free to carry the digital wallet 700 to any place he or she so desires easily and hassle free. Further, such implementation could find application in amusement parks, theatres, and other such places, as a closed or semi-closed financial instrument.

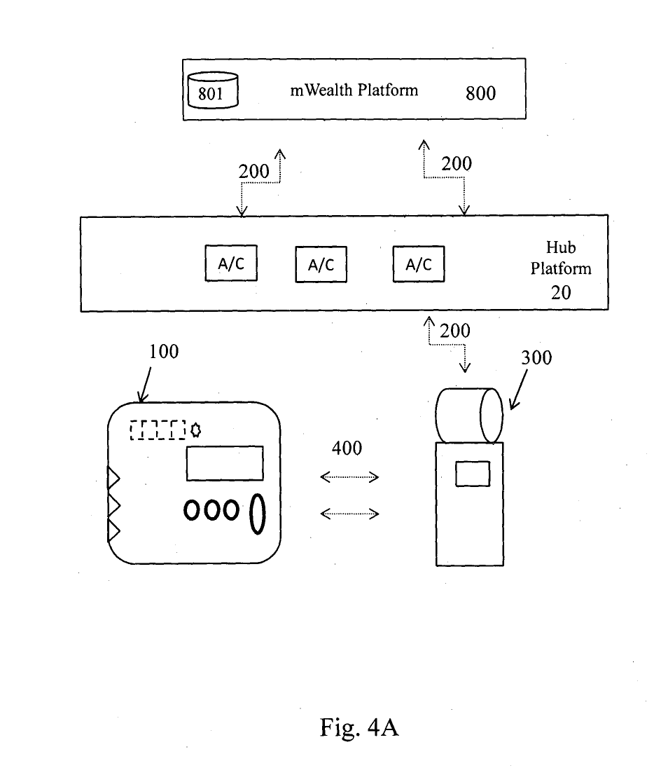

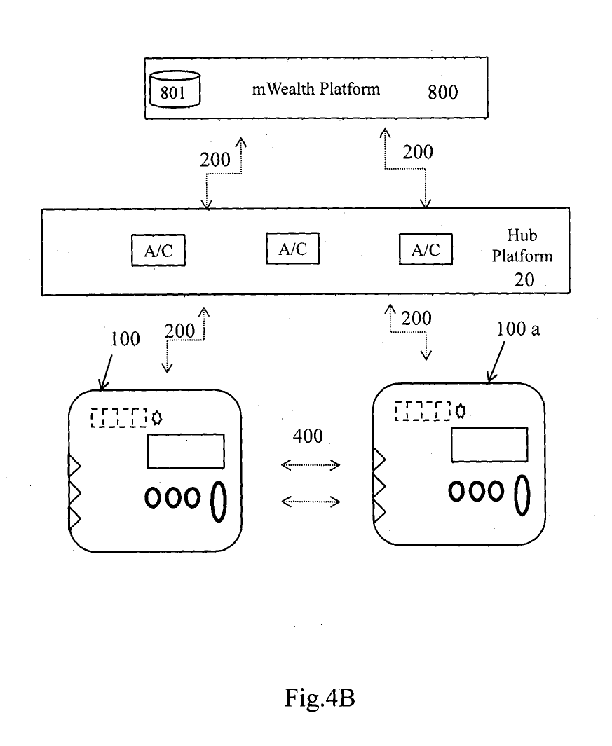

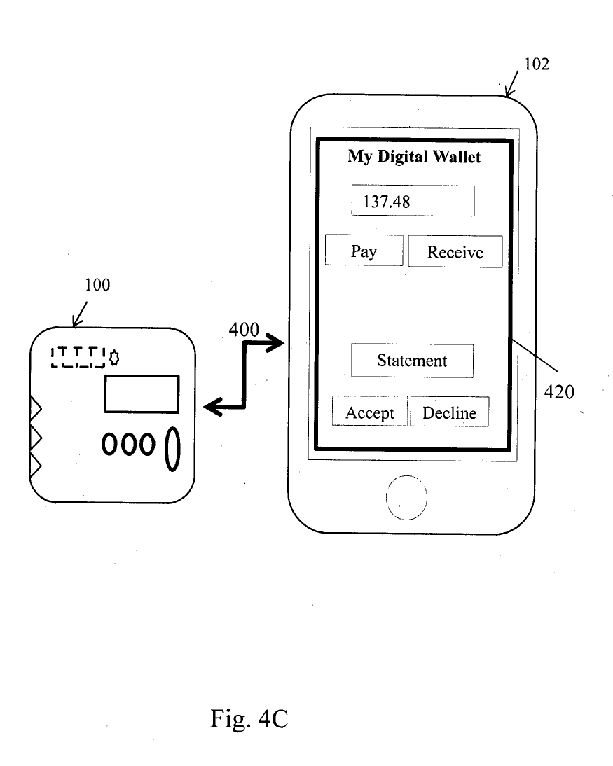

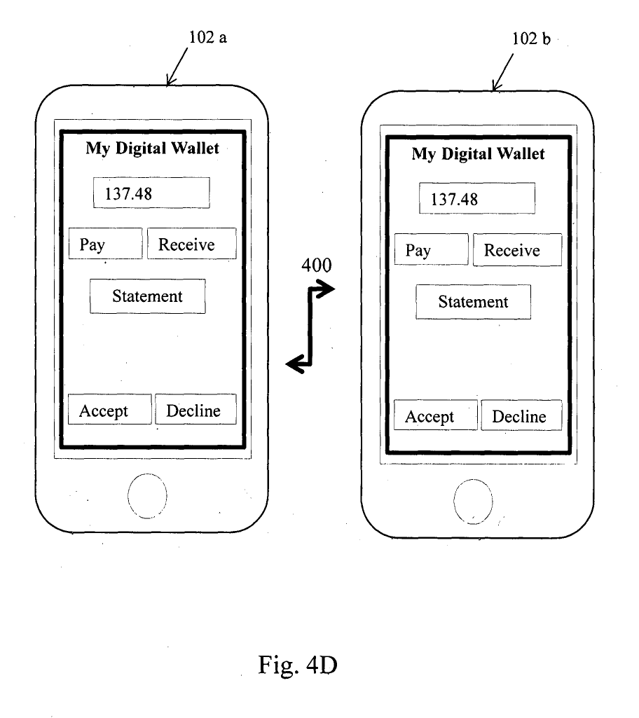

The network backbone of the financial institution along with the interplay between the digital wallets and the network backbone for facilitating transactions will now be explained in details with reference to FIGS. 4-10.

Referring to FIG. 4A, illustrates a system for implementing electronic transactions between various users of digital wallets in a financial system. Each of one or more digital wallets is adapted to be used by multiple users. Suitable example of the financial system may be a banking system. In one embodiment, the electronic transactions are carried out in different currencies.

As shown in FIG. 4A, there is a server 800 (M-platform) for storing financial and personal information of the users in the server database 801. Further, there is a platform 20 capable of connecting to the server 800 via a wide area network. The platform 20 is adapted to communicate with at least one digital wallet 100 or the transaction terminal 300 for facilitating the electronic transactions.

In one embodiment, the transaction terminal 300 and the wallets 100 are embodied in a single device. Suitable example of the device may include mobile phones, tablet computers and other PDAs. In various embodiments, the transaction terminal 300 and the wallets 100 may be in a software or hardware level.

In one embodiment, the hub platform 20 is capable of replicating the user account stored in the server database 801 and adapted to mimic the user accounts at hub platform 20 as shown in FIG. 4A to create mimicked accounts. The mimicked accounts include not only include the financial information of the bank accounts of the users, but also different other type of information, such as loyalty points, frequent flyer miles, user Accounts, and club membership information of the users, which is stored in the database 801. Further, the transaction terminal 300 is capable of connecting to hub platform 20 via WAN interface 200.

Further, according the present invention, one or more digital wallets 100 are adapted to communicate with each other and with the at least one transaction terminal 300 for facilitating the electronic transactions via short range communication 400 and able to synchronize the carried electronic transaction when the digital wallet gets communicably coupled to the at least one transaction terminal.

Referring to FIG. 4B, there is shown a communication between two digital wallets 100 and 100 (a) (Implemented as a hardware device) via a communication medium 400. The digital wallets 100, 100 (a) are capable of communicating with each other via low power short communication 400 for facilitating transactions in an offline manner without the need to be connected to the Wide Area Network, such as the internet. This carried transaction gets synchronized whenever either of the first digital wallets 100 gets communicably coupled to the Hub platform 20 via the WAN interface 200.

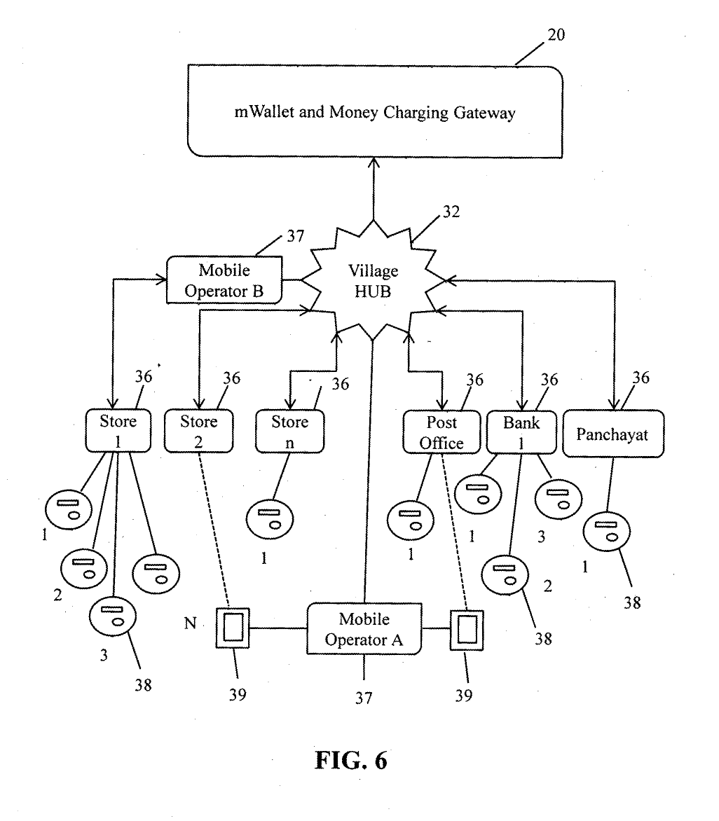

FIG. 4C illustrates a communication between two digital wallets, first digital wallet 100 implemented as a hardware device and a second digital wallet 102 (implemented as a software application referred to as software wallet) via a communication medium 400. Further, the two digital wallets 100, 102 facilitate the electronic transactions in an offline manner without the need to be connected to the Wide Area Network. This carried transaction gets synchronized when either of the first digital wallet 100 or the second digital wallet 102 gets communicably coupled to the server 800 or the platform hub 20 via the WAN interface 200 (as shown in FIG. 6A).

FIG. 4D illustrates a communication between a first digital wallet 102 a (Implemented as a software application) and a second digital wallet 102 b (Implemented as a software application) via a communication medium 400. In this particular case, the transaction between the first digital wallet 102 a and the second digital wallet 102 b is carried out without the need of server 800 (shown in FIG. 6A). This carried transaction gets synchronized whenever either of the first digital wallet 102 or the second digital wallet 102 gets communicably coupled to the server 800 or the platform hub 20 (as shown in FIG. 4A) via the WAN interface 200.

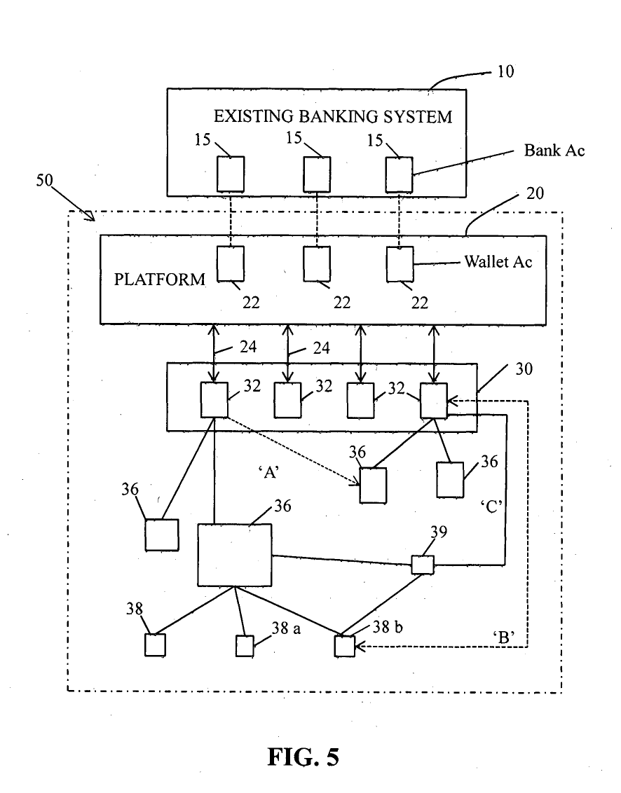

Now as in FIG. 5, there is shown a block diagram of a system 50 for enabling electronic transactions with a banking system 10. The system 50 includes a platform 20 in communication with the banking system 10. The platform 20 is adapted to replicate bank account 15 of the users by creating account replicas 22 (mimicked accounts) therein. The account replicas 22 mimic the account details including information such as name, date of birth, money in account, credit/debit limits, and other such details, and stores the information in the platform 20. Furthermore, the account 22 stores the e-money which the user has chosen to transfer or withdraw from their account 15, in a conjunct wallet account. Value in the wallet account is the only amount available for transactions thus isolating the main banking account from hacking. The system 50 can connect with other systems including closed pre-paid instruments or membership only systems. Here, account 22 can be updated using terminal 36, POS or other data entry systems.

The system 50 further includes a nodal layer 30 in direct communication with the platform 20. The nodal layer 30 includes one or more hubs 32 in direct communication with the platform 20 via communication network 24. These hubs 32 are typically located in various geographical locations or could be virtual installations in a cloud network representing various zones. These hubs 32 are conceptually the bridge between the users and the platform 20, which may be geographically spaced.

The system 50 further includes various terminals 36, communicably coupled to the hubs 32. As shown in FIG. 5, the terminals 36 are usually coupled to the hubs 32 in their geographical location, however, such coupling should not be construed as a limitation. In one embodiment, the terminals 36 can be interchangeably coupled to hubs 32 in different geographical locations, as depicted by arrow “A”, as and when required. Furthermore, there is no requirement for the terminal 36 to have 24×7 connectivity with the hub 32.

The system 50 further includes plurality of digital wallets 38. The features and functions of the digital wallets are as described above. The digital wallets 38 are carried by various users. In one embodiment, the digital wallets 38 are adapted to come in communicable contact with terminals 36. In one embodiment, the digital wallets 38 come in contact with the proximal terminals 36, in the same hub 32. In another embodiment, the digital wallets 38 may be configured to communicably contact different hubs 32, in different geographical regions, as shown by arrow B. This provides roaming capabilities to the digital wallets 38. In other words, using such capabilities, the digital wallets 38 in a non-home location may still be able to communicate with the system 50. An approach to efficiently manage such seamless movement has been explained earlier by way of a Home Account Register and a Visitor Account Register. In a third embodiment, the digital wallet 39, having inbuilt wireless communication capabilities could connect directly, or through repeaters, the hub, as shown by arrow C.

In one embodiment, such communicable contact allows the digital wallets 38 to perform financial transactions with the terminals 36. Moreover, as described above, the digital wallets 38 (38a and 38b) are adapted to perform financial transactions with each other in offline or unconnected mode, i.e., without connection with the terminal 36, hub 30 or platform 20. In this embodiment, the digital wallets 38 reconcile all the transactions with the platform 20 when they come online at a later point in time.

The digital wallets 38 may be hardware based devices (marked with labels 38), or may be software level modules (marked with label 39, and also called soft wallets 39) running on known in the art data processing devices, such as tablets, computing devices, mobile phones or smart phones.

In another embodiment, a digital wallet 38 performs a financial transaction directly with soft wallet 39, without the need for connection and reconcile, the transaction with the platform 20 using the inbuilt wireless communication capabilities of wallet 39 to connect with the hub 32, as shown by arrow C.

It will be apparent to a person skilled in the art that the system 50 and its various components, such as platform 20, nodal layer 30, and terminals 36 may include various hardware and software functionalities to enable various functionalities. Suitable hardware functionalities may include one or more computing devices including servers, one or more storage memories, and the like, which are essential to perform the functionalities of the system 50.

Further, in one embodiment, the communicable coupling between the hubs 32 and the terminals 36, may be through wired or wireless means, such as GSM networks operated by various mobile operators. Moreover, the communicable coupling between the digital wallets 38 and the terminals 36 may be using wireless means, such as Bluetooth Low Energy, and other similar wireless protocols. However, it should be clearly understood that such communicable coupling should not be construed as a limitation to the present invention.

The implementation of the system 50 (as shown in FIG. 5) will now be explained with reference to FIG. 6. As in FIG. 6, the platform 20 is shown to be connected to a hub 32, which is a village hub 32. As further shown, the village hub 32 is communicably coupled to plurality of terminals 36 in stores (store 1, store 2, store 3 . . . store n), coffee shops, banks, panchayats and other establishments. The terminals 36 are point of contact of the plurality of digital wallets 38 with the system 50 (as shown in FIG. 5), and accordingly, with the banking system 10. In one embodiment, these terminals 36 may be located in post office, banks, and panchayats (local town halls) of a geographical location.

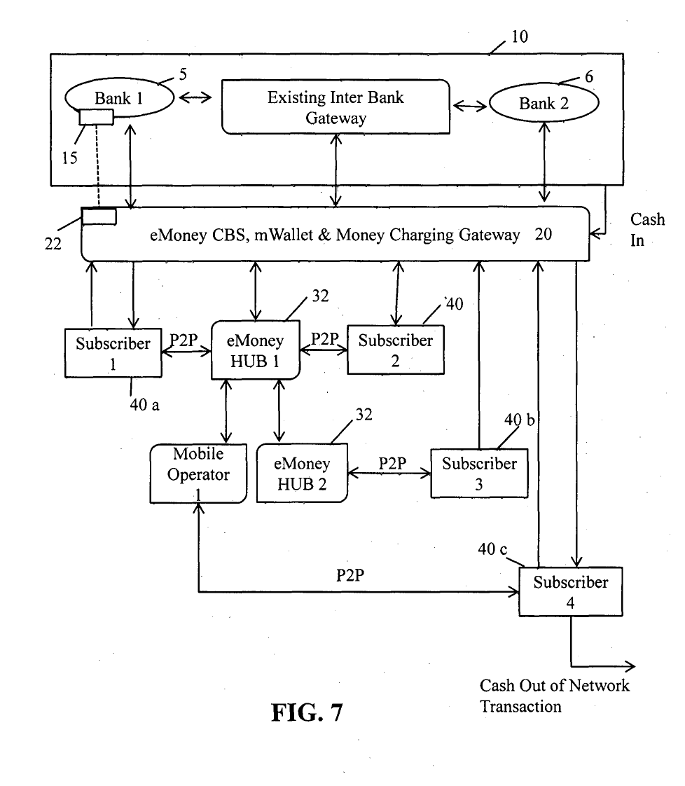

FIG. 7 depicts a block diagram of an implementation of the system 50 (as shown in FIG. 5) for carrying out electronic transactions between subscribers. In FIG. 5, there are shown some elements of an existing banking system 10, namely banks 5, 6 coupled to an Inter Bank Gateway 7. The platform 20 is coupled to the banking system 10 via standard interfaces. Various subscribers 40 are coupled to different hubs 32 using digital wallets 38 or soft wallets 39.

In the transaction flow, a subscriber can go to a bank, ATM, merchant device or use other means of access to their bank account 15 and withdraw electronic cash from the bank. This electronic cash is transferred from bank account 15 via the platform and stored in the replica account 22. This is further transferred to digital wallets 38 of the subscriber, and readies the digital wallets 38 for further transaction.

The platform also supports the ability to transfer funds from one subscriber (40a) to another subscriber across different hubs (40b).

The platform supports the ability for a subscriber to take in cash from bank, ATM, merchant device or other means and convert it into e-money for crediting the associated digital wallet 38 or 39. The system also supports the ability for a subscriber (40c) to withdraw physical money from the bank, ATM, merchant device or other means by using the digital wallet 38 or 39.

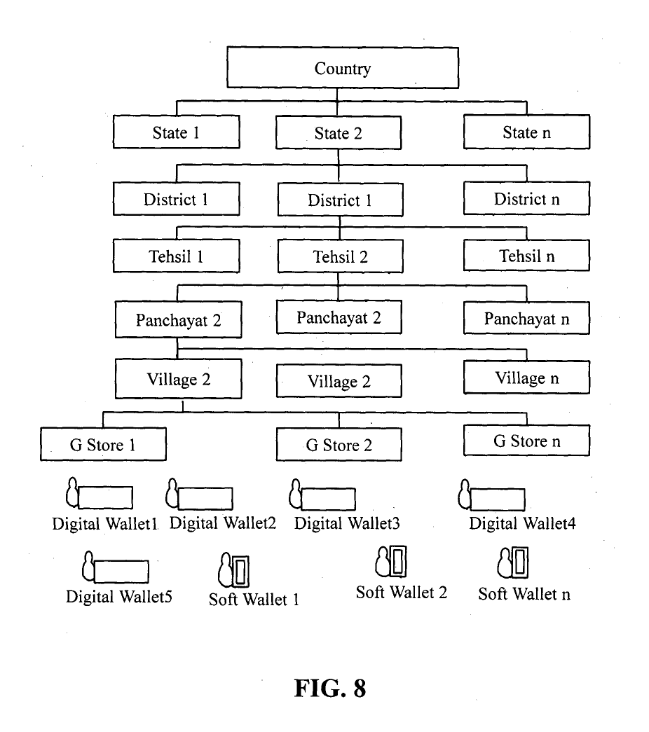

FIG. 8 depicts an architecture model for carrying out transaction in the system 50 (as shown in FIG. 5). As shown in FIG. 8, the digital wallets 38 and soft wallets 39 are communicably coupled to the terminals 36 over a layer of villages, panchayats, tehsils, districts, and states. These architectural aspects drive the scalability and helps in achieving high volume transactions. It will be apparent to a person skilled in the art that a high percentage of transactions will be conducted within the proximity of the subscriber. By storing balance information on the wallet as well as pushing the current balance of the user to the local hub reduces the traffic to the platform. A hub and spoke built along with ring architecture brings scalability, self-healing and redundancy abilities to the platform.

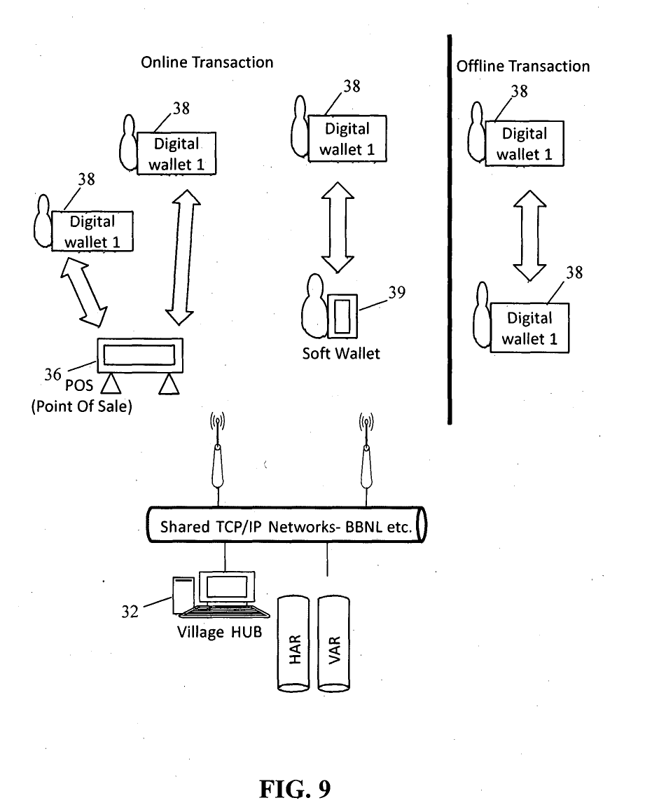

FIG. 9 depicts online and offline implementation of transactions. As mentioned above the system 50 (as shown in FIG. 5) includes capabilities to carry out transactions in unconnected or offline mode. Such capabilities are depicted where digital wallets 38 and soft wallets 39 carry out transactions with each other in offline mode, and reconciliation of the transaction happens when the digital wallets 38 come in communicable contact with the POS (terminals 36). This is especially advantageous in situations where there is intermittent or total lack of connectivity. In such situations, the system 50 (as shown in FIG. 5) does not have any down time and can still operate to carry out transactions between digital wallets. Enabling this operation also significantly reduces the transactional load on the central processing computers.

In this manner, the present invention provides a system and method for implementing high volume electronic transactions.

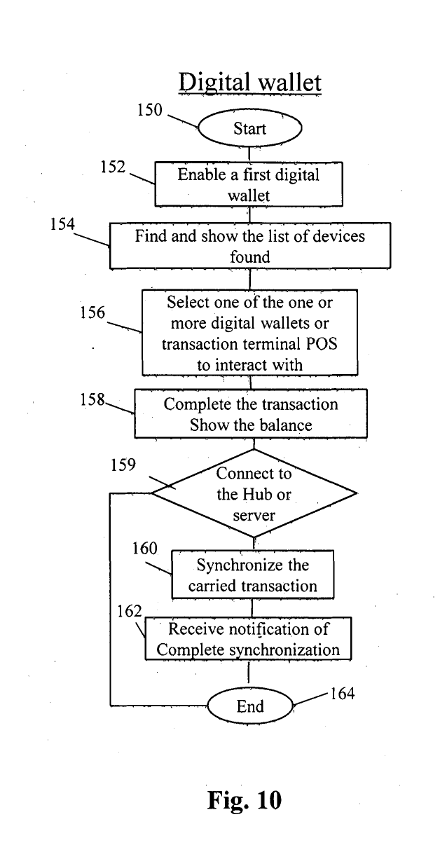

FIG. 10 illustrate flow charts for implementing electronic transactions between various users carrying a digital wallet. The method starts at step 150. Thereafter, the user enables the digital wallet by switch on or turns on the digital wallet. In one embodiment, the user first authenticates himself/herself to the digital wallet, at step 152. If the authentication is successful, the wallets show the balance to the respective users. Thereafter, the digital wallet finds and shows the nearby devices like digital wallets or transaction terminal or POS to the user, at step 154. At step 156, the user selects one or more digital wallets or transaction terminals POS to interact with. Thereafter, in step 158 the digital wallets send/receives the transaction request to the desired digital wallet for electronic transaction. After successful transaction, the balance is displayed on digital wallet screen, at step 158. The digital wallet may synchronize with server, at step 162 if it is connected to the server or hub platform via the internet by third party device, wherein the third party device is a software digital wallet, a transaction terminal, a hardware digital wallet and the third party device is connected to the server or the hub platform via WAN interface. After synchronization, the digital wallet receive a notification of completion of synchronization from the server or hub platform The method then stops at step 164.

It will be evident to one skilled in the art that the digital wallet or the soft wallet can not only store e-money and doing payment transactions but is capable of performing inter-account, inter-bank and third party transfers. Furthermore, the wallet is capable of cash withdrawals, making loan payments, making investments, paying premiums for product and services and offering other services associated with financial institutions.

It can be seen by one skilled in the art that this system for providing high volume transactions as well as unconnected transactions has many uses outside of the banking and financial industry.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

What is claimed is:

1. A system for implementing electronic transactions between various users in a financial system, the system comprising:
at least one server coupled to the financial system for replicating and storing financial and personal information of the users;
at least one transaction terminal capable of connecting to the server via a wide area network; and
one or more digital wallets adapted to,
communicate with each other or with the at least one transaction terminal in an offline manner for carrying electronic transactions, and
synchronize the carried electronic transaction when the digital wallet gets communicably coupled to the at least one transaction terminal.

2. The system as claimed in claim 1 comprising at least one hub capable of connecting to the server and the at least one terminal via the wide area network.

3. The system as claimed in claim 1, wherein the server comprises a database for storing the financial and personal information of the users.

4. The system as claimed in claim 3, wherein data at the server comprises loyalty points, frequent flyer miles, user Accounts, and club membership information of the users.

5. The system as claimed in claim 2, wherein the server and the hub share information of the users via wide area network.

6. The system as claimed in claim 1, wherein the communication means is low power short range communication.

7. The system as claimed in claim 6, wherein the low power short range communication is at least one of Bluetooth, Infrared and Radio Frequency Identification (RFID), Near Field Communication (NFC), WiFi, ANT, or ZigBee.

8. The system as claimed in claim 1, wherein the at least one transaction terminal is a kiosk, a point of sale (POS), an automated teller machine (ATM) or a merchant machine, or a software element running on a mobile telephone.

9. The system as claimed in claim 1, wherein the synchronization between the one or more digital wallets and the at least one terminal comprises conciliation and reconciliation of electronic transactions carried within and between the one or more digital wallets.

10. The system as claimed in claim 1, wherein each of one or more digital wallets may be a standalone hardware device, a software application installed on a communication device such as mobile phone, tablets and the like.

11. The system as claimed in claim 1, wherein each of one or more digital wallets is adapted to be used by multiple users.

12. The system as claimed in claim 1, wherein the electronic transactions are carried out in different currencies.

13. The system as claimed in claim 1, wherein the at least one transaction terminal and the one or more digital wallets are embodied in a single device.

14. A method for implementing electronic transactions between various users, each of the user carrying a digital wallet, the method comprising:
enabling a first digital wallet;
selecting one of the one or more digital wallets; and
sending an electronic transaction request to the selected digital wallet from the first digital wallet via a communication means,
wherein the electronic transaction gets synchronized with a server or a hub, when either of the selected digital wallet or the first digital wallet gets communicably coupled to a wide area network.

15. The method as claimed in claim 14, wherein the one or more digital wallets communicate with each other via low power short range communication.

16. The method as claimed in claim 14, wherein carrying the electronic transaction further comprises sending and receiving of credit and debit information between the selected digital wallet via low power short range communication.

17. The method as claimed in claim 15 or 16, wherein the low power short range communication is Bluetooth, Infrared and Radio Frequency Identification (RFID), Near Field Communication (NFC), WiFi, ANT, or ZigBee.

18. The method as claimed in claim 14 comprising transacting with at least one transaction terminal in communication with the server or the hub via Wide Area Network for synchronizing the carried electronic transactions.

19. The method as claimed in claim 18, wherein the at least one transaction terminal is a standalone device, a software application, a firmware or a mobile device that allows the one or more digital wallets to communicate with the server or the hub via the Wide Area Network.

20. The method as claimed in claim 14, wherein the synchronization between the one or more digital wallets with the server or the hub comprises conciliation and reconciliation of electronic transactions carried between the one or more digital wallets.

21. The method as claimed in claim 14, wherein data in the server and the hub comprises loyalty points, frequent flyer miles, and club membership information of the users.

22. The method as claimed in claim 14, wherein the server and the hub share information of the users via wide area network.

23. The method as claimed in claim 14, wherein the at least one transaction terminal is a kiosk, a point of sale (POS), an automated teller machine (ATM) or a merchant machine or a software element running on a mobile telephone.

24. The method as claimed in claim 14, wherein each of one or more digital wallets may be a standalone hardware device or a software application installed on a communication device such as mobile phone, tablets and the like.

25. The method as claimed in claim 24, wherein each of one or more digital wallets is adapted to be used by multiple users.

26. The method as claimed in claim 14, wherein the carried electronic transaction is carried out in offline manner via one of the at least low power short range communication means using the one or more digital wallets.

27. The method as claimed in claim 18, wherein the at least one transaction terminal and the one or more digital wallets are embodied in a single device.

28. A method for implementing electronic transactions between various users in a financial system such as a banking system, each of the user carrying a digital wallet associated with a bank account, the method comprising:
replicating information in the bank accounts to create mimicked accounts for the users;
storing the mimicked accounts in a database;
carrying electronic transactions between the digital wallets in an offline manner;
synchronizing the carried transactions whenever any of the digital wallets get communicably coupled to a Wide Area Network; and
updating the bank accounts based on the synchronization of the carried transactions.

29. The method as claimed in claim 28, wherein the synchronization between the one or more digital wallets and the at least one terminal comprises conciliation and reconciliation of electronic transactions carried within and between the one or more digital wallets.

30. The method as claimed in claim 29, wherein the synchronization between the one or more digital wallets is facilitated via a transaction terminal.

31. The method as claimed in claim 30, wherein the transaction terminal is a kiosk, a point of sale (POS), an automated teller machine (ATM) or a merchant machine, or a software element running on a mobile telephone.

32. The method as claimed in claim 28, wherein each of one or more digital wallets may be a standalone hardware device, a software application installed on a communication device such as mobile phone, tablets and the like.
